(19) United States
(12) Patent Application Publication
(10) Pub. No.: US 2026/0281534 A1
(43) Pub. Date: Sep. 17, 2026

(54) DETECTION METHOD, DETECTION DEVICE, COMPUTER APPARATUS, AND COMPUTER-READABLE STORAGE MEDIUM

(71) Applicant: ARASHI VISION INC., Shenzhen (CN)

(72) Inventors: Hanfei XU, Shenzhen (CN); Xiaolin TANG, Shenzhen (CN)

(73) Assignee: ARASHI VISION INC., Shenzhen (CN)

(21) Appl. No.: 19/671,202

(22) Filed: May 7, 2026

Related U.S. Application Data
(63) Continuation of application No. PCT/CN2024/081984, filed on Mar. 15, 2024.

(51) Int. Cl. H04N 23/61; G06V 10/25; G06V 10/764; G06V 10/766; G06V 10/77; H04N 23/63; H04N 23/69

(52) U.S. Cl. CPC H04N 23/61; G06V 10/25; G06V 10/764; G06V 10/766; G06V 10/7715; H04N 23/632; H04N 23/69; G06V 2201/07

(57) ABSTRACT

The present disclosure provides a detection method, a detection device, a computer apparatus, and a computer-readable storage medium. By determining a candidate region in a target image captured by a first lens with a larger capturing range, and by capturing, by a second lens with a smaller capturing range, to obtain a region image corresponding to each candidate region, it is possible to determine a region image detection box of a target object in each region image, and map each region image detection box to the target image, so as to obtain a target detection box in the target image.

### CROSS-REFERENCE TO RELATED APPLICATION

This application is a continuation of International Application No. PCT/CN2024/081984, filed on Mar. 15, 2024. The entire content of this application is hereby incorporated by reference in its entirety.

### BACKGROUND

The present disclosure relates, but is not limited, to a detection method, a detection device, a computer apparatus, and a computer-readable storage medium.

With the rapid development of image processing technology and the continuous iteration of capturing devices, capturing devices with target detection functions have been widely adopted. Such capturing devices can identify and locate specific objects in images. An object to be detected (or a target object) can be identified by different detection methods, so that a detection box corresponding to the target object can be displayed in, for example, a capturing preview screen.

However, when target objects vary significantly in size, conventional target detection methods may exhibit low detection accuracy and low detection efficiency, degrading the user experience.

### SUMMARY

The following is a summary of the subject matter described in detail in the present disclosure. This summary is not intended to limit the scope of the present disclosure.

The present disclosure provides a detection method, a detection device, a computer apparatus, and a computer-readable storage medium.

An aspect of the present disclosure provides a detection method for a capturing device. The capturing device includes a first lens and a second lens, where a capturing range of the second lens is configured to be smaller than a capturing range of the first lens. The detection method includes:

determining at least one candidate region in a target image captured via the first lens;

capturing, via the second lens, a region image corresponding to each of the at least one candidate region;

determining a region image detection box of a target object in the region image; and

mapping the region image detection box to the target image, to obtain a target detection box in the target image.

According to some implementations of the present disclosure, determining at least one candidate region in the target image captured via the first lens includes:

determining whether the target object is present in the target image; and

in response to determining that the target object is present in the target image, determining the at least one candidate region in the target image.

According to some implementations of the present disclosure, determining whether the target object is present in the target image includes:

performing feature extraction on the target image to obtain a feature image;

performing binary classification on the feature image to obtain a classification confidence, where the classification confidence represents a probability that the target object is present in the target image; and

comparing the classification confidence with a first confidence threshold to obtain a comparison result, and determining whether the target object is present in the target image based on the comparison result.

According to some implementations of the present disclosure, determining at least one candidate region in the target image includes:

performing detection box regression on the feature image to obtain a plurality of first candidate detection boxes, and a plurality of confidences corresponding to the plurality of first candidate detection boxes; and

among the first candidate detection boxes with respective confidences greater than a second confidence threshold, designating each independent first candidate detection box as an independent candidate region of the at least one candidate region, and combining the first candidate detection boxes that at least partially overlap with one another into a single candidate region of the at least one candidate region.

According to some implementations of the present disclosure, the first confidence threshold is inversely correlated with the second confidence threshold.

According to some implementations of the present disclosure, capturing, via the second lens, the region image corresponding to each of the at least one candidate region includes:

controlling, via a gimbal, a capturing angle (or an imaging angle) of the second lens to configure each of the at least one candidate region to be positioned within a capturing range of the second lens; and

capturing, via the second lens, to obtain the region image corresponding to each of the at least one candidate region.

According to some implementations of the present disclosure, a center of the least one candidate region is configured to coincide with a center of the capturing range of the second lens, and an area ratio of each of the at least one candidate region to the capturing range of the second lens is configured to be within a predetermined range.

According to some implementations of the present disclosure, determining the region image detection box of the target object in the region image includes:

performing detection box regression on the region image to obtain a second candidate detection box in the region image and a confidence of the second candidate detection box; and

designating the second candidate detection box with the confidence greater than a third confidence threshold as the region image detection box.

According to some implementations of the present disclosure, the third confidence threshold is configured to be greater than the second confidence threshold.

According to some implementations of the present disclosure, mapping the region image detection box to the target image, to obtain the target detection box in the target image includes:

extracting a feature point from an image within the region image detection box; and

based on the feature point, mapping the region image detection box in the region image to a corresponding position in the target image, to obtain the target detection box in the target image.

According to some implementations of the present disclosure, the detection method further includes:

displaying the target image and the target detection box at a user interface of the capturing device.

According to some implementations of the present disclosure, the detection method further includes:

in response to a deletion operation performed by a user on the target detection box at the user interface, deleting the target detection box.

According to some implementations of the present disclosure, the first lens includes a wide-angle lens, and the second lens includes a telephoto lens.

Another aspect of the present disclosure provides a detection device that is implemented into a capturing device. The capturing device includes a first lens and a second lens, where a capturing range of the second lens is smaller than a capturing range of the first lens. The detection device includes:

a first determining module, configured to determine at least one candidate region in a target image captured via the first lens;

a capturing module, configured to capture, via the second lens, a region image corresponding to each of the at least one candidate region;

a second determining module, configured to determine a region image detection box of a target object in the region image; and

a mapping module, configured to map the region image detection box to the target image, to obtain a target detection box in the target image.

Another aspect of the present disclosure provides a computer apparatus, including a memory and a processor, where the memory stores a computer program, and the processor is configured to execute the computer program to perform the operations of any detection methods disclosed herein.

Another aspect of the present disclosure provides a computer-readable storage medium storing a computer program, where the computer program, when executed by a processor, is configured to perform the operations of any detection method disclosed herein.

In the detection method, the detection device, the computer apparatus, and the computer-readable storage medium provided in the present disclosure, the candidate region is first selected from the target image captured via the first lens with a larger capturing range. Further, based on the region image that is corresponding to each candidate region and captured by the second lens with a smaller capturing range, the region image detection box corresponding to the target object is determined. Thus, the detection efficiency is improved while the detection accuracy of the target object is ensured, thereby enhancing the user experience.

### BRIEF DESCRIPTION OF DRAWINGS

The following drawings, which are incorporated herein and form a part of the present disclosure, illustrate example implementations of the present disclosure and, together with the detailed description, serve to explain the principles of the implementations. In the following drawings, like reference numerals refer to like elements. The followings drawings are provided for illustrative purposes according to various disclosed embodiments and are not intended to limit the scope of the present disclosure. Other embodiments and modifications will be apparent to those skilled in the art without departing from the scope and spirit of the disclosure, and without requiring undue experimentation.

FIG. 1 is a schematic diagram of a capturing device according to some embodiments of the present disclosure.

FIG. 2 is a flowchart of a detection method, according to some embodiments of the present disclosure.

FIG. 3 is a schematic diagram of candidate regions in a target image, according to some embodiments of the present disclosure.

FIG. 4 is a schematic diagram of candidate regions in a region image, according to some embodiments of the present disclosure.

FIG. 5 is a schematic diagram of a region image detection box in a region image, according to some embodiments of the present disclosure.

FIG. 6 is a schematic diagram of a target detection box in a target image, according to some embodiments of the present disclosure.

FIG. 7 is a flowchart of determining at least one candidate region in a target image captured via a first lens, according to some embodiments of the present disclosure.

FIG. 8 is a flowchart of determining whether a target object is present in a target image, according to some embodiments of the present disclosure.

FIG. 9 is a flowchart of determining at least one candidate region in a target image, according to some embodiments of the present disclosure.

FIG. 10 is a flowchart of performing a capturing process on at least one candidate region, according to some embodiments of the present disclosure.

FIG. 11 is a flowchart of determining a region image detection box of a target object in a region image, according to some embodiments of the present disclosure.

FIG. 12 is a flowchart of mapping a region image detection box to a target image to obtain a target detection box in the target image, according to some embodiments of the present disclosure.

FIG. 13 is a flowchart of a detection method, according to some embodiments of the present disclosure.

FIG. 14 is a block diagram of a detection device according to some embodiments of the present disclosure.

FIG. 15 is a block diagram of a computer apparatus, according to some embodiments of the present disclosure.

The present disclosure will be described with reference to the accompanying drawings.

### DETAILED DESCRIPTION

The following will provide a clear description of the technical solutions in the embodiments of the present disclosure with reference to the accompanying drawings in the embodiments of the present disclosure. Obviously, the described embodiments are only part of the embodiments of the present disclosure and not all embodiments. Based on the implementations in the present disclosure, all other implementations obtained by those skilled in the art without creative efforts shall fall within the protection scope of the present disclosure. It should be noted that, unless otherwise indicated or inherently contradictory, the implementations disclosed herein and the features in the implementations may be combined with each other in any suitable manner.

With the rapid development of image processing technology and the continuous iteration of capturing devices (or imaging devices), such as mobile phones and cameras, capturing devices with target detection functions have been widely adopted in fields such as image annotation and target tracking. These imaging devices can identify and locate specific objects in images. Target (or object) detection can be performed via a single-camera detection or dual-camera detection approach.

However, in the single-camera detection approach, when there is a significant variation in target sizes, it is challenging to simultaneously detect both large and small targets effectively, resulting in decreased detection accuracy and recall rate. In the dual-camera detection approach, the lens that meets the requirements for small target recognition needs to perform exhaustive capturing and target recognition, which significantly increases the number of detections and the processing time, resulting in decreased detection efficiency and poor user experience.

Exemplary implementations of the present disclosure provides a detection method, a detection device, a computer apparatus, and a computer-readable storage medium. Through determining candidate regions within a target image (or an image to be detected) captured by a first lens with a larger capturing range, and capturing, via a second lens with a smaller capturing range, a region image corresponding to each candidate region, a region image detection box of a target object (or an object to be detected) may be determined within each region image. Through mapping each region image detection box to the target image, a target detection box in the target image may be obtained, and the detection and presentation of the target object may be realized. Through selecting candidate regions based on the target image captured by the first lens, and determining the region image detection box corresponding to the target object based on the region image that is corresponding to each candidate region and captured by the second lens, the detection efficiency of the target object may be improved while the detection accuracy of the target object may be maintained, thereby enhancing the user experience.

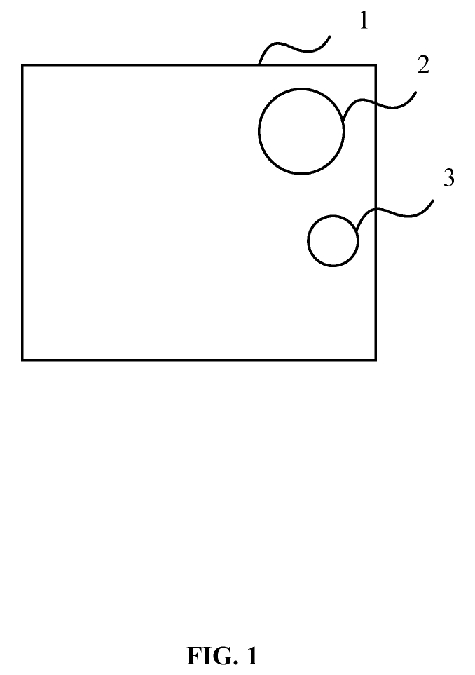

In one embodiment, a detection method is provided for a capturing device (or an imaging device) 1 shown in FIG. 1. The capturing device 1 may be, for example, a camera, a mobile phone, a conference device, or any device capable of capturing images. The capturing device 1 includes a first lens 2 configured with a relatively wide capturing range (i.e., field of view), and a second lens 3 configured with a relatively narrow capturing range (i.e., field of view). In some implementations, the capturing range of the first lens 2 may be wider than the capturing range of the second lens 3. The second lens 3 may include, for example, a lens with an adjustable focal length and an adjustable capturing angle. In some embodiments, the second lens 3 may be configured with a relatively narrow capturing range, an adjustable focal length, and a substantially same resolution as the first lens 2, enabling the second lens 3 to capture images with enhanced clarity and improved detail representation. The second lens 3, having the relative narrow capturing range and the adjustable capturing angle, may perform multiple captures, via adjusting the capturing angle to cover the entire capturing range of the first lens 2.

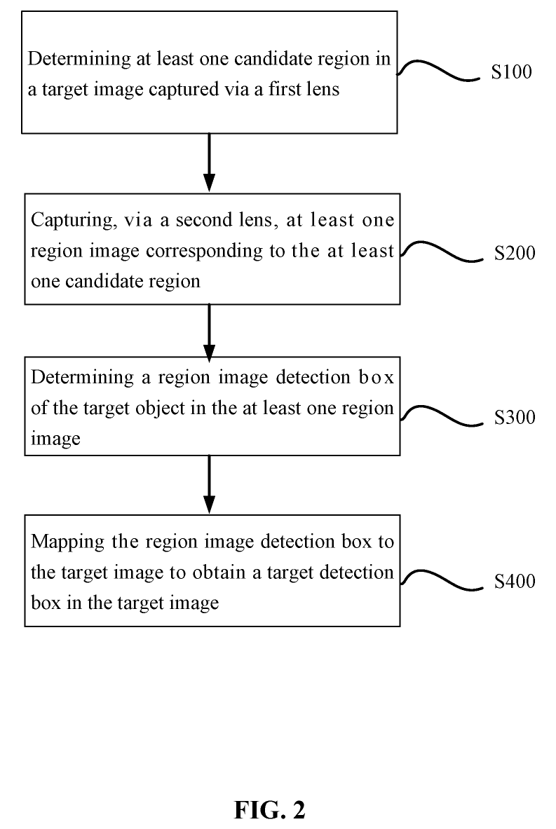

As shown in FIG. 2, the detection method includes the following operations.

Operation S100: determining at least one candidate region in a target image captured via the first lens.

Operation S200: capturing, via the second lens, to obtain at least one region image corresponding to the at least one candidate region.

Operation S300: determining a region image detection box of the target object in the at least one region image.

Operation S400: mapping the region image detection box to the target image, to obtain a target detection box in the target image.

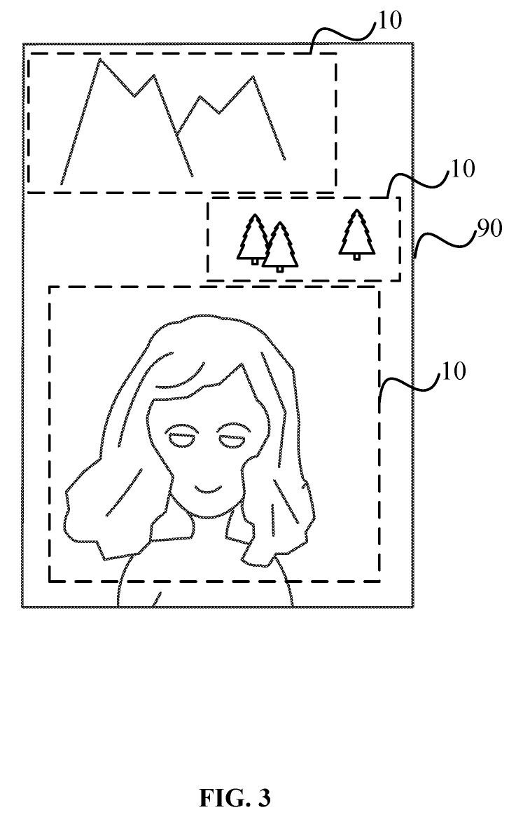

In operation S100, as shown in FIG. 3, a target image 90 is captured via the first lens 2 of the capturing device 1, and at least one candidate region 10 is determined within the target image 90. The target image 90 refers to an image on which an object detection is to be performed, i.e., the target image 90 may include one or more target objects for detection. The target image 90 may be, for example, displayed as part of a capturing preview screen on an interaction interface (or a user interface) of the capturing device 1. In the subsequent operations, each candidate region 10 may serve as a basis for the image capturing performed by the second lens 3 to obtain a corresponding region image.

The candidate region 10 refers to a region in which a target object is likely to be present. For example, the candidate region 10 may be a region in which the likelihood of the presence of the target object satisfies a predetermined condition. For discussion purposes, FIG. 3 shows three candidate regions 10, in which the target objects are shown as mountains, trees, and a human, respectively. In the subsequent operations, based on the region image corresponding to the candidate region 10, a region image detection box for the target object may be determined in the region image, thereby enabling a pre-detection of the target object.

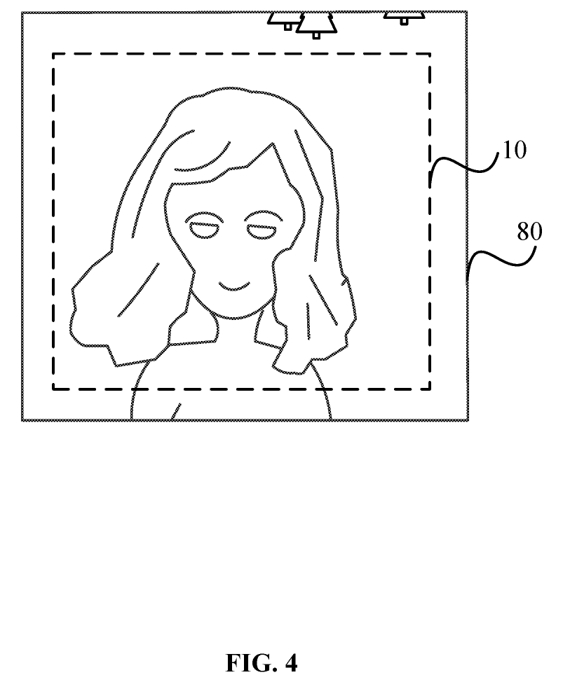

In operation S200, as shown in FIG. 4, the second lens 3 of the capturing device 1 captures an image of the candidate region 10 in the target image 90 (illustrated in FIG. 3), to obtain, a region image 80 corresponding to the candidate region 10. In some implementations, the region image 80 may one-to-one correspond to the candidate region 10. Each candidate region 10 may be entirely encompassed by the corresponding region image 80. For discussion purposes, FIG. 4 merely illustrates a single region image 80 corresponding to the candidate region 10 in which the target object is a human.

As the candidate region 10 refers to a region where the likelihood of the presence of the target object satisfies a predetermined condition, when capturing imaging via the second lens 3, it may be no longer necessary to exhaustively capturing and identifying the target object across the entire scene. Instead, it may be sufficient to merely capture the regions corresponding to respective candidate regions 10 where the target objects are likely to be present. Thus, the number of region images to be captured may be reduced, along with the computational load associated with subsequent processing of the region images, thereby improving the overall detection efficiency. In addition, when the second lens 3 is configured with an adjustable focal length, the region images captured via the second lens 3 may exhibit enhanced clarity and improved detail representations, thereby improving the accuracy of subsequent determination of the region image detection box and the detection accuracy.

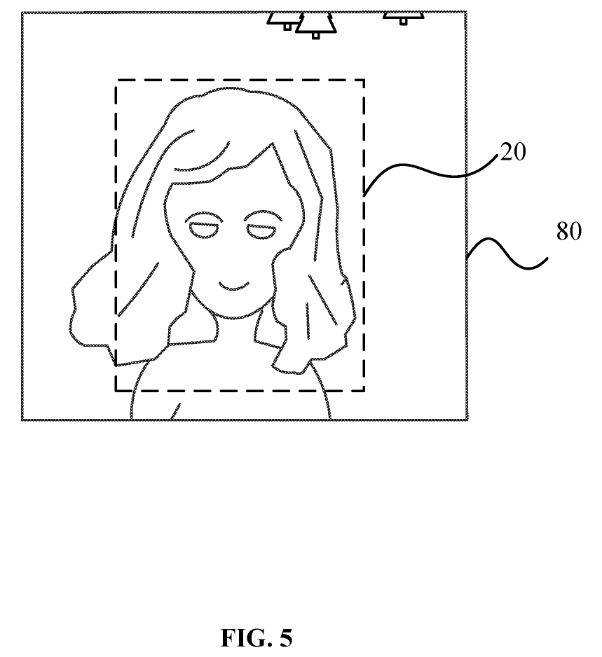

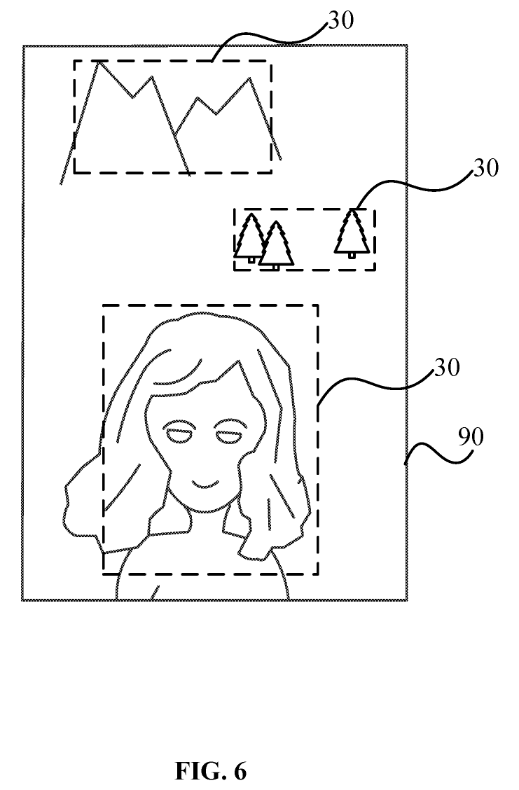

In operation S300, as shown in FIG. 5, a detection is performed on each region image 80 to determine, within each region image 80, a region image detection box 20 corresponding to the target object. For discussion purposes, FIG. 5 merely illustrates the single region image 80 corresponding to the candidate region 10 (illustrated in FIG. 3), in which the target object is a human. The determination of the region image detection box 20 may be implemented by a target detection model and algorithm based on deep learning. For example, a YOLO (You Only Look Once) model or a Centernet model may be adopted to perform detection box regression on each region image 80, and the convolutional neural network (CNN) of the model may be adopted to determine the region image detection box 20 of the target object in each region image 80. It should be noted that when the region image 80 includes the target object, the region image detection box 20 corresponding to the target object may be determined in the region image 80. Conversely, when the region image 80 does not include the target object, the region image detection box 20 corresponding to the target object may not be determined in the region image 80.

The region image detection box 20 refers to a detection box in image detection technologies, and is employed to locate and identify the target object in the region image 80. The region image detection box 20 may be, for example, in the shape of a rectangle, which may be defined by the coordinate values of the four corners of the rectangle in the region image 80, or defined by the coordinate value of one corner and the length and the width of the rectangle in the region image 80. Thus, the position and the size of the target object in the region image 80 may be accurately marked by the region image detection box 20, facilitating the presentation of the target object.

In operation S400, as shown in FIG. 6, each determined region image detection box 20 within the region image 80 (illustrated in FIG. 5) may be mapped to the target image 90, so that the region image detection box 20 may be displayed as a target detection box 30 located at the corresponding position in the target image 90. When the target image 90 is displayed as a capturing preview screen on the interaction interface of the capturing device 1, the target detection box 30 within the target image 90 may mark the target object in the entire capturing preview screen, thereby realizing the detection and the presentation of the target object. For discussion purposes, FIG. 6 shows three target detection boxes 30 in the target image 90, in which the target objects are mountains, trees, and a human, respectively. The determination of the other two target detection boxes 30 in which the respective target objects are mountains and trees may be similar to the determination of the target detection box 30 in which the target object is a human. Detailed descriptions of the determination operations may refer to the above descriptions rendered in connection with FIGS. 4-6.

In the present disclosure, through determining at least one candidate region 10 in the target image 70 captured via the first lens 2 with a relatively wide capturing range, and capturing, via the second lens 3 with a relatively narrow capturing range to obtain the region image 80 corresponding to each candidate region 10, the region image detection box 20 of the target object may be determined in the region image 80. Further, through mapping the region image detection box 20 in the region image 80 to the target image 90, the target detection box 30 may be determined in the target image 90, thereby realizing the detection and the presentation of the target object. Through selecting the candidate regions 10 based on the target image 90 captured via the first lens 2, and determining the region image detection box 20 corresponding to the target object based on the corresponding region image 80 captured by the second lens 3, the detection efficiency may be improved while the detection accuracy of the target object may be ensured, thereby enhancing the user experience.

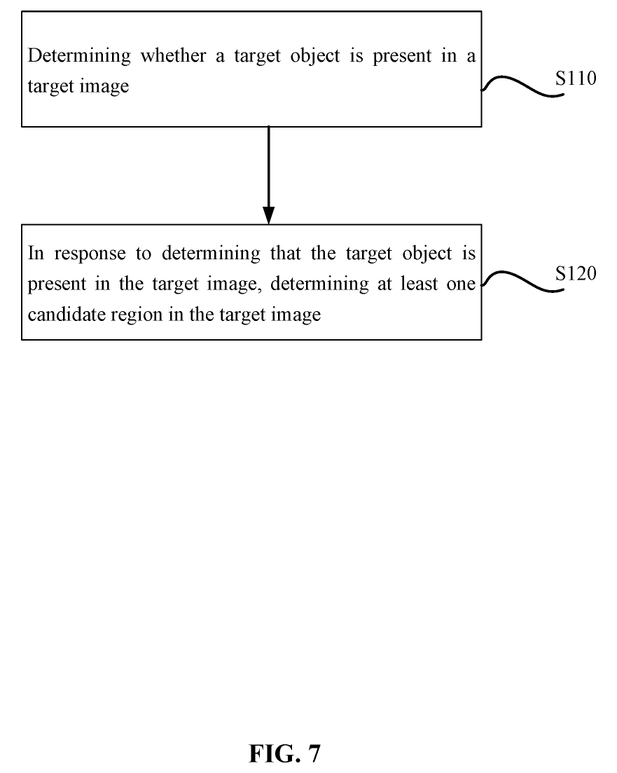

In some implementations, as shown in FIG. 7, determining at least one candidate region 10 in the target image 90 (illustrated in FIG. 3) captured via the first lens 2 (illustrated in FIG. 1) may include the following operations.

Operation S110: determining whether the target object is present in the target image.

In operation S110, whether the target object is present in the target image 90 may be determined. For example, binary classification processing or other suitable methods may be employed to classify whether the target image 90 includes the target object or not. Then the presence or absence of the target object in the target image 90 may be determined based on the classification result.

Operation S120: in response to determining that the target object is present in the target image, determining at least one candidate region in the target image.

In operation S120, if the target object is determined to be absent in the target image 90, the subsequent operations becomes meaningless, as it would result in unnecessary consumption of system resources. Therefore, the subsequent determination of the candidate region 10 may be performed only when the target object is determined to be present in the target image 90.

In the present disclosure, whether the target object is present in the target image 90 may be determined first. The determination process of the candidate region 10 may be executed only when the target object is determined to be present in the target image 90. This ensures that at least one of the subsequently obtained region images 80 may include the target object, thereby enabling the determination of the region image detection box 20 in the region image 80. As a result, when the target object is determined to be absence in the target image 90, unnecessary executions of the subsequent operations may not be performed, thereby reducing the resource consumption and improving the overall detection efficiency.

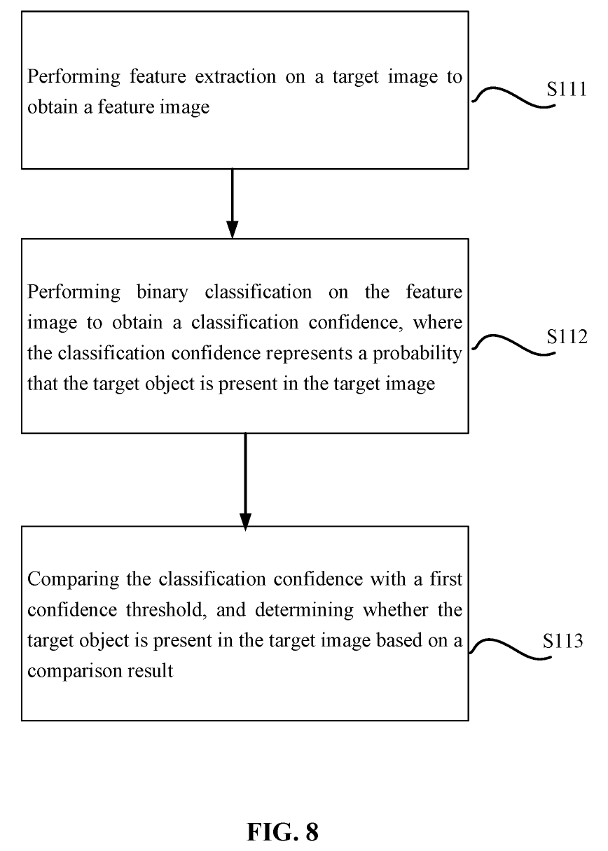

In some implementations, as shown in FIG. 8, determining whether the target object is present in the target image includes the following operations.

Operation S111: performing feature extraction on the target image to obtain a feature image.

In operation S111, feature extraction may be performed on the target image 90 (illustrated in FIG. 3) to obtain a feature image (or feature map) corresponding to the target image 90. For example, a convolutional neural network may be employed to perform the feature extraction on the target image 90, and an obtained feature image may be the result of the target image 90 processed by the convolutional layers of the neural network. The obtained feature image may represent a specific feature in the neural network space, facilitating the subsequent binary classification processing based on the specific feature.

Operation S112: performing binary classification on the feature image to obtain a classification confidence (or classification confidence score), where the classification confidence represents a probability that the target object is present in the target image.

In operation S112, for example, a YOLO model or a Centernet model may be employed to perform the binary classification on the feature image to obtain the classification confidence. The classification confidence of the feature image may indicate the probability that the target object is present in the target image 90. A greater classification confidence may represent a higher probability that the target object is present in the target image 90 corresponding to the feature image.

Operation S113: comparing the classification confidence with a first confidence threshold, and determining whether the target object is present in the target image based on a comparison result.

In operation S113, the obtained classification confidence may be compared with the first confidence threshold, and whether the target object is present in the target image 90 (illustrated in FIG. 3) may be determined based on the comparison result. In some embodiments, the first confidence threshold may be an empirical value obtained from experiments. In some embodiments, the first confidence threshold may be set and adjusted according to scenario requirements. For example, the first confidence threshold is α. When the obtained classification confidence of the feature image is less than or equal to α, the target object is determined to be not present (or be absent) in the target image 90. When the obtained classification confidence is greater than α, the target object is determined to be present in the target image 90.

In the present disclosure, through performing the feature extraction on the target image 90 to obtain the feature image, and performing the binary classification on the feature image to obtain the classification confidence, whether the target object exists in the target image may be determined based on the comparison result between the classification confidence and the first confidence threshold. The determination of the presence of the target object serves as the basis for deciding whether to execute the operation of determining the candidate region 10. Through performing the feature extraction and the binary classification, the accuracy of the classification confidence that represents the probability that the target object is present in the target image 90 may be ensured which, in turn, improves the accuracy of determining whether the target object is present in the target image 90.

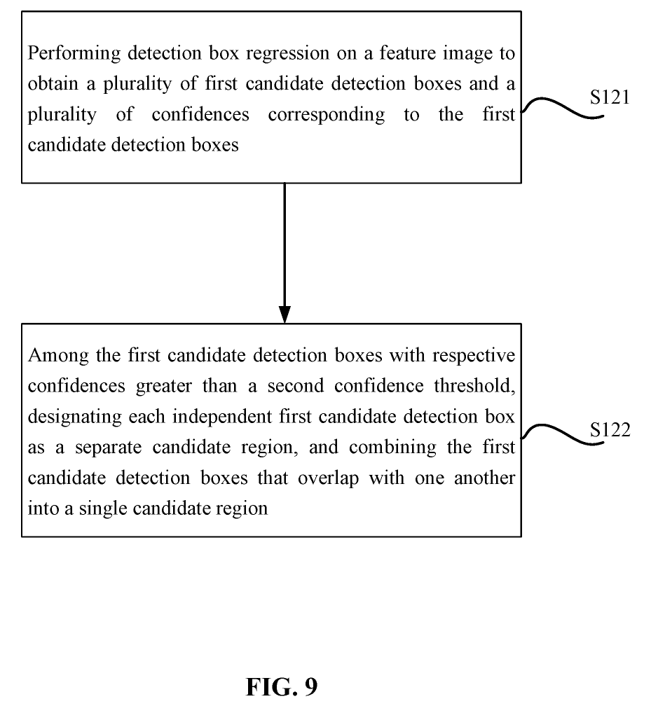

In some embodiments, as shown in FIG. 9, determining at least one candidate region in the target image may include the following operations.

Operation S121: performing detection box regression on the feature image to obtain a plurality of first candidate detection boxes and a plurality of confidences corresponding to the plurality of first candidate detection boxes.

In operation S121, in target detection tasks, detection box regression may be employed to locate the precise position of the bounding box of the target object via a model. For example, a YOLO model or a Centernet model may be used to perform the detection box regression on the feature image corresponding to the target image 90 (illustrated in FIG. 3) to obtain a plurality of first candidate detection boxes. The sizes of the respective first candidate detection boxes may vary. The first candidate detection boxes may not overlap (or may be mutually independent) or may at least partially overlap with one another. As used herein, “at least partially overlap” indicates that each detection box may have only a partial portion that overlaps with another detection box, or that the entirety of each detection box may overlap with another detection box. In some embodiments, in the obtained plurality of first candidate detection boxes, at least two first candidate detection boxes are mutually independent (or may not overlap) with one another. In some embodiments, in the obtained plurality of first candidate detection boxes, at least two first candidate detection boxes at least partially overlap with one another. In some embodiments, in the obtained plurality of first candidate detection boxes, at least two first candidate detection boxes are mutually independent (or do not overlap) with one another, and at least two first candidate detection boxes at least partially overlap with one another.

Each first candidate detection box has a corresponding confidence (or confidence score). The confidence of the first candidate detection box is a key indicator for measuring the performance of the first candidate detection box and determining the recall rate of the first candidate detection box. The confidence of the first candidate detection box represents both the probability that the target object is present in the first candidate detection box, and the degree of alignment between the first candidate detection box and the true boundary of the target object. A greater confidence of the first candidate detection box may indicate a higher probability that the target object exists in the first candidate detection box, and a higher degree of alignment between the first candidate detection box and the true boundary of the target object.

Operation S122: among the first candidate detection boxes with respective confidences greater than a second confidence threshold, designating each independent first candidate detection box as each independent candidate region, and combining the first candidate detection boxes that at least partially overlap with one another into a single candidate region.

In operation S122, the second confidence threshold may be, for example, an empirical value obtained from experiments, and may also be set and adjusted according to scenario requirements. The first candidate detection boxes having the respective confidences greater than the second confidence threshold, i.e., those whose performance satisfies predetermined requirements, may be selected. Among the first candidate detection boxes with the confidence greater than the second confidence threshold, each independent first candidate detection boxes may be designated as separate (or independent) candidate regions 10, and the first candidate detection boxes that at least partially overlap with one another may be combined into a single candidate region 10. Thus, one or more candidate regions 10 corresponding to the first candidate detection boxes with the confidence greater than the second confidence threshold may be obtained.

In the present disclosure, the detection box regression on the feature image may be performed to obtain a plurality of first candidate detection boxes and a plurality of confidences corresponding to the plurality of first candidate detection box. Among the first candidate detection boxes with the confidence greater than the second confidence threshold, each independent first candidate detection box may be designated as a separate (or an independent) candidate region 10, and the first candidate detection boxes that at least partially overlap with one another may be combined into a single candidate region 10. Thus, the candidate regions 10 may be determined, providing a basis for capturing the region image 80 via the second lens 3 in the subsequent operations. Through determining the candidate regions 10 from the first candidate detection boxes with the confidence greater than the second confidence threshold, the performance of the first candidate detection boxes configured to form the candidate region 10 may be ensured. As a result, the selected first candidate detection boxes may exhibit a higher probability of containing the target object and a higher degree of alignment with the true boundary of the target object, which improves the determination accuracy of the candidate region 10 and the detection accuracy.

In some embodiments, the determination of whether the target object is present in the target image 90 may be omitted, and at least one candidate region 10 may be directly determined in the target image 90. For example, the feature extraction may be performed on the target image 90 to obtain a feature image, and the detection box regression may be performed on the feature image to obtain a plurality of first candidate detection boxes and a plurality of corresponding confidences. Then, among the first candidate detection boxes with the confidence greater than the second confidence threshold, each independent first candidate detection box may be designated as a separate (or an independent) candidate region 10, and the first candidate detection boxes that at least partially overlap with one another may be combined into a single candidate region 10, thereby determining the candidate region 10.

In some embodiments, the first confidence threshold may be configured to be inversely correlated with the second confidence threshold.

The first confidence threshold that is compared with the classification confidence, and the second confidence threshold that is compared with the confidence of the first candidate detection box, may be configured to be inversely correlated. That is, when the first confidence threshold is relatively high, the corresponding second confidence threshold may be relatively low. Thus, when the classification confidence is greater than the first confidence threshold, i.e., the probability that the target object exists in the target image 90 is relatively high, based on the relatively low second confidence threshold, more first candidate detection boxes may be selected to form the candidate regions 10. Accordingly, the recall rate of both the first candidate detection boxes and the candidate regions 10 may be ensured.

Further, when the first confidence threshold is relatively low, the corresponding second confidence threshold may be relatively high. Thus, when the classification confidence is greater than the first confidence threshold, i.e., the probability that the target object exists in the target image 90 is relatively low, based on the relatively high second confidence threshold, fewer first candidate detection boxes may be selected, to form the candidate region 10. Accordingly, detection boxes that are falsely detected or do not satisfy the required criteria may be excluded.

For example, when the first confidence threshold is α, the second confidence threshold may be (1-α)/2+0.25, so that the first confidence threshold and the second confidence threshold are inversely correlated. This formula is only an empirical formula representing the correspondence between the second confidence threshold and the first confidence threshold, and is not intended to limit the second confidence threshold.

In the present disclosure, through configuring the first confidence threshold and the second confidence threshold to be inversely correlated, when the probability that the target object exists in the target image is relatively high, the recall rate of both the first candidate detection boxes and the candidate region 10 may be ensured. Further, when the probability that the target object exists in the target image 90 is relatively low, the first candidate detection boxes that are falsely detected or do not satisfy the required criteria may be excluded. Accordingly, the determination accuracy of the candidate regions 10 under different circumstances may be improved, and the detection accuracy may be enhanced.

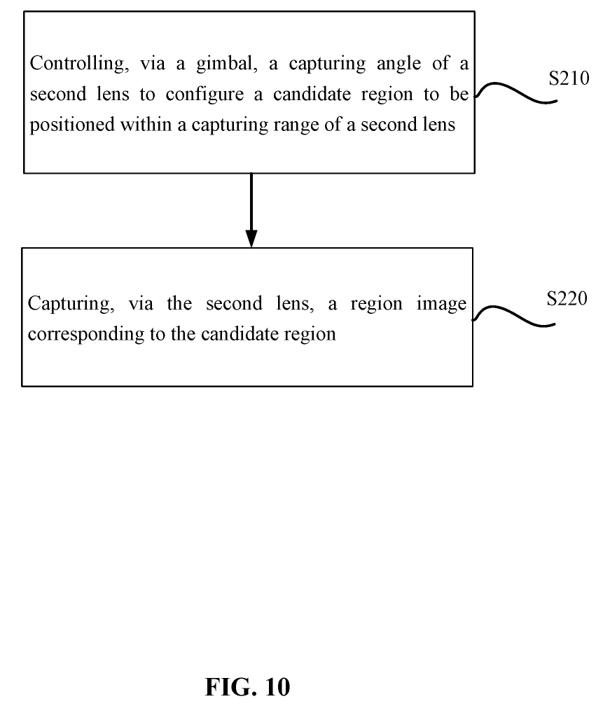

In some embodiments, capturing, via the second lens 3, to obtain the region image 80 corresponding to each candidate region 10 includes the following operations. The following capturing process may be performed on each candidate region 10 in sequence as shown in FIG. 10.

Operation S210: controlling, via a gimbal, a capturing angle of the second lens to configure the candidate region to be positioned within a capturing range of the second lens.

In operation S210, the capturing assembly 1 that includes the second lens 3 may be rigidly coupled to a gimbal, i.e., the relative position of the gimbal and the second lens 3 may remain unchanged. The gimbal may be rotatable, thereby rotating the second lens 3 around one or more rotation axes (e.g., a yaw, roll, and/or pitch axis) with respective to the gimbal. A capturing angle of the second lens 3 may be adjustable via controlling an orientation of the gimbal (e.g., gimbal angles or Euler angles). Thus, the region covered by the capturing range of the second lens 3 may be adjustable to ensure that the candidate region 10 is positioned within the capturing range of the second lens 3, while maintaining the capturing angle of the second lens 3.

Operation S220: capturing, via the second lens, the region image corresponding to the candidate region.

In operation S220, in response to configuring the candidate region 10 to be positioned within the capturing range of the second lens 3, the second lens 3 may capture an image of the candidate region 10 to obtain the region image 80 corresponding to the candidate region 10, such that the candidate region 10 is entirely encompassed within the corresponding region image 80.

After completing the capturing process of one candidate region 10, the capturing process may be performed for another candidate region 10, and so on, until the capturing processes of all candidate regions 10 are completed. Then, the respective region images corresponding to respective candidate regions 10 may be obtained.

In the present disclosure, the gimbal may control (or adjust) the capturing angle of the second lens 3 to control (or adjust) the area covered by the capturing range of the second lens, thereby ensuring that each candidate region 10 is located within the capturing range of the second lens 3. The second lens 3 may capture the respective region images 80 corresponding to the respective candidate regions 10, providing a basis for the subsequent determination of the respective region image detection boxes 20. Through capturing, the respective candidate regions 10 via the second lens 3 having a relatively narrow capturing range, the region images 80 may exhibit enhanced clarity and fine details, improving the accuracy of subsequent determination of the respective region image detection boxes 20 and the detection accuracy.

In some implementations, a center of the candidate region 10 may be configured to coincide with a center of the capturing range of the second lens 3, and an area ratio of the candidate region 10 to the capturing range of the second lens 3 may be configured to be within a predetermined range.

The capturing angle of the second lens 3 may be adjustable, such that the center of each candidate region 10 coincides with the center of the capturing range of the second lens 3, and the candidate region 10 is located at a central portion of the corresponding region image 80 captured via the second lens 3. The focal length of the second lens 3 may be adjustable, and the capturing range of the second lens 3 may be adjustable via controlling the focal length of the second lens 3. Thus, the area ratio of each candidate region 10 to the capturing range of the second lens 3 may be configured to be within a predetermined range. As a result, the area ratio of the candidate region 10 to the corresponding region image 80 captured via the second lens 3 may remain substantially consistent, thereby ensuring that the size of the target object within the region image 80 fluctuates within a narrow range. Accordingly, the subsequent determination of the region image detection box 20 may be facilitated.

For example, the capturing range of the second lens 3, e.g., the shape of the region image 80, may be rectangular. The geometric center of each candidate region 10 may be aligned with the center of the capturing range of the second lens 3. The area ratio of each candidate region 10 to the capturing range of the second lens 3 may be configured to be within a predetermined range, such as approximately one-half or another predefined ratio. For example, the predetermined range may be 0.5-0.6. Thus, the respective candidate regions 10 occupy substantially the same position and substantially the same proportion within the corresponding region images 80.

In the present disclosure, through configuring the center of each candidate region 10 to coincide with the center of the capturing range of the second lens 3, and configuring the area ratio of each candidate region 10 to the capturing range of the second lens 3 to be within a predetermined range, the respective candidate regions 10 may be ensured to occupy substantially the same position and substantially the same proportion within the corresponding region image 80. This facilitates the use of a same model to determine the region image detection box 20 of the target object in each region image 80. As a result, a high recall rate and high detection accuracy may be achieved, and the user experience may be enhanced.

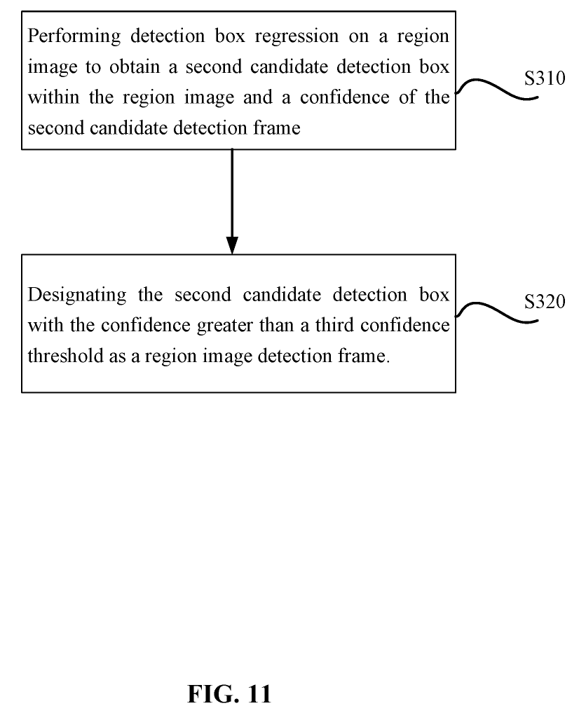

In some implementations, as shown in FIG. 11, determining a region image detection box of the target object in the region image includes the following operations.

Operation S310: performing detection box regression on a region image to obtain a second candidate detection box within the region image and a confidence of the second candidate detection box.

In operation S310, in some embodiments, a YOLO model or a Centernet model may be employed to perform the detection box regression on each region image 80 to obtain a second candidate detection box within each region image 80. Each second candidate detection box may be located in the corresponding region image 80, and may be employed to locate the target object in the region image 80.

Each second candidate detection box has a corresponding confidence (or confidence score). The confidence of the second candidate detection box may be a key indicator for measuring the performance of the second candidate detection box. The confidence of the second candidate detection box may also determine the recall rate of the second candidate detection box. The confidence of the second candidate detection box may indicate the probability that the target object exists in the second candidate detection box, and the degree of alignment between the second candidate detection frame and the true boundary of the target object. A greater confidence of the second candidate detection box may indicate a higher probability that the target object exists in the second candidate detection box, and a higher the degree of alignment between the second candidate detection box and the true boundary of the target object.

Operation S320: designating the second candidate detection box with the confidence greater than a third confidence threshold as the region image detection box.

In operation S320, in some embodiments, the third confidence threshold may be, for example, an empirical value obtained from experiments. In some embodiments, the third confidence threshold may be set and adjusted according to scenario requirements. The second candidate detection box with the confidence greater than the third confidence threshold, i.e., with the performance satisfying predetermined requirements, may be designated as the region image detection box 20. Accordingly, the region image detection box 20 may be determined in at least one of the region images 80.

In the present disclosure, the detection box regression may be performed on each region image 80 to obtain the second candidate detection box of each region image 80, and the confidence of each second candidate detection box. Then the second candidate detection box with the confidence greater than the third confidence threshold may be designated as the region image detection box 20, thereby determining the region image detection box 20 in at least one of the region images 80. Since the region image detection box 20 is determined as the second candidate detection box with the confidence greater than the third confidence threshold, the performance of the region image detection box 20 may be ensured. That is, the determined region image detection box 20 may exhibit a higher probability of containing the target object and a higher degree of alignment with the true boundary of the target object. As a result, the detection accuracy of the target object may be improved, thereby enhancing the user experience.

In some embodiments, the third confidence threshold may be configured to be greater than the second confidence threshold.

When selecting the first candidate detection box to form the candidate region 10, a relatively low second confidence threshold may be desirable to allow more first candidate detection boxes to be selected in the determination of the candidate region 10, thereby ensuring the recall rate of the candidate region 10. When selecting the second candidate detection box as the region image detection box 20, a relatively high third confidence threshold may be desirable to allow fewer second candidate detection boxes to be selected in the determination of the region image detection box 20, thereby ensuring the accuracy of the region image detection box 20. Therefore, the third confidence threshold may be configured to be greater than the second confidence threshold.

In the present disclosure, through configuring the third confidence threshold to be greater than the second confidence threshold, more first candidate detection boxes may be allowed to be selected in the determination of the candidate region 10, and fewer second candidate detection boxes may be allowed to be selected in the determination of the region image detection box 20. As a result, the recall rate of the candidate region 10 and the accuracy of the region image detection box 20 may be ensured and, accordingly, the accuracy of the detection result may be improved.

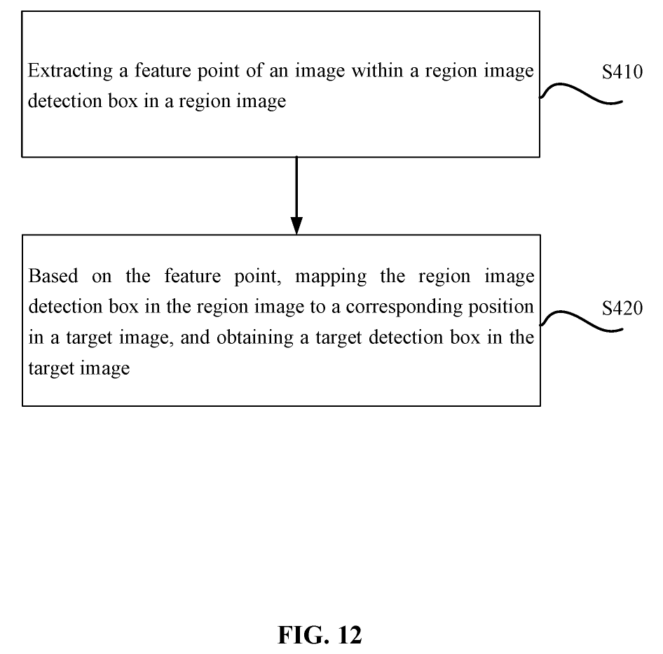

In some implementations, as shown in FIG. 12, mapping each region image detection box to the target image, to obtain a target detection box in the target image includes the following operations.

Operation S410: extracting a feature point from an image within a region image detection box in a region image.

In operation S410, when mapping the region image detection box 20 to the target image 90, a matching relationship between the region image detection box 20 in the region image 80 and the target image 90 may be obtained first. One or more feature points may be exacted from the image located within the region image detection box 20. The image within the region image detection box 20 may refer to a portion of the region image 80, and located within the region image detection box. The feature point may include pixel points located within the region image detection box 20, and exhibiting prominent and stable image features. The pixel points may be adopted for a position calibration of the image across different scale spaces. The feature point of the image within each region image detection box 20 may be employed as the basis for determining the matching relationship between the region image detection box 20 and the target image 90. In some embodiments, the feature point of the image within each region image detection box 20 may be extracted via a Scale Invariant Feature Transform (SIFT) algorithm.

Operation S420: based on the feature point, mapping the region image detection box in the region image to a corresponding position in the target image, and obtaining a target detection box within the target image.

In operation S420, as the feature points are employed as the basis for determining the matching relationship between the region image detection box 20 in the region image 80 and the target image 90, each region image detection box 20 in the region image 80 may be mapped to a corresponding position in the target image 90 based on the feature points. For example, the region image detection box 20 may be located at a first position in the region image 80, and the region image detection box 20 may be mapped to a second position in the target image 90. The second position in the target image 90 may correspond to the first position in the region image 80. Respective region image detection boxes 20 located at respective first positions in the region image 80 may be mapped to respective, corresponding second positions in the target image 90. This ensures that the region image detection box 20 mapped to the target image 90 may correspond to the same target object as the region image detection box 20 in the region image 80 corresponds, thereby obtaining the target detection box 30 in the target image 90.

For discussion purposes, the feature points in the image within the region image detection box 20 in the region image 80 may be referred to as first feature points. In some embodiments, second feature points in the target image 90 may be determined based on a same algorithm (e.g., SIFT) as the first feature points. The respective second feature points may match the respective first feature points. A mapping matrix may be calculated based on the first feature points within the region image detection box 20 in the region image 80 and the second feature points within the target image 90. Then, based on the mapping matrix, the region image detection box 20 in the region image 80 may be mapped to a corresponding position in the target image 90, thereby obtaining the target detection box 30 in the target image 90 as illustrated in FIG. 6. Accordingly, the target object in the target image 90 may be marked and presented, e.g., to a user.

In the present disclosure, through extracting the feature points of the image within each region image detection box 20, each region image detection box 20 may be mapped to the corresponding position in the target image 90 based on the feature points. Thus, the region image detection box 20 mapped to the target image 90 may be ensured to correspond to the same target object as the region image detection box 20 in the region image 80. Accordingly, the target object in the target image 90 may be marked and presented.

In some implementations, the detection method further includes displaying the target image 90 and the target detection box 30 on an interaction interface of the capturing device 1.

Upon obtaining the target detection box 30 in the target image 90, the target image 90 and the target detection box 30 illustrated in FIG. 6 may be displayed at the interaction interface of the capturing device 1, and may be displayed as the capturing preview screen of the capturing device 1. The user of the capturing device 1 may select, delete, adjust the size, and perform other operations on each target detection box 30.

In the present disclosure, through displaying the target image 90 together with the target detection box 30 at the interaction interface (or user interface) of the capturing device 1, the user may clearly and intuitively perceive the target detection box 30 in the current target image 90, with the target object marked by the target detection box 30 and presented. In addition, the target detection box 30 that the user perceives at the user interface may be final target detection box 30, ensuring a concise interface display and enhancing the user experience.

In some embodiments, the detection method further includes: in response to a deletion operation of a user on the target detection box in the interaction interface, deleting the target detection box to which the deletion operation is directed.

In some implementations, a target detection box 30 displayed at the screen of the interaction interface may have a problem, such as being incompatible with the current scene or having low necessity. When the user performs a deletion operation on the target detection box 30 at the interaction interface, the corresponding target detection box 30 may be deleted, and the deleted target detection box 30 may be no longer displayed at the screen of the interactive interface.

For example, the deletion operation may be performed by clicking an icon control at the interaction interface. The user may choose to delete all target detection boxes 30 through the deletion operation, or to delete one or more target detection boxes 30 through the deletion operation. When the deletion operation selects one or more target detection boxes 30 to be deleted, the selected target detection boxes 30 may be deleted accordingly, such that the deleted target detection boxes 30 are no longer displayed on the screen of the interaction interface.

In the present disclosure, when the user performs a deletion operation on the target detection box 30 at the interaction interface, the selected target detection box 30 may be deleted. This allows unnecessary or undesired target detection boxes 30 to be removed from being displayed on the screen of the interaction interface, enabling a user to interact with the target detection box 30. The operation is simple and ensures the practicality of the target detection box 30 retained at the interaction interface, thereby enhancing the user experience.

In some implementations, the first lens 2 may include a wide-angle lens, and the second lens 3 may include a telephoto lens.

The wide-angle lens may have a relatively large or wide capturing range (or field of view), and the telephoto lens may have a relatively small or narrow capturing range (or field of view). The wide-angle lens having a wider field of view may be desirable for acquiring images corresponding to larger scenes. Therefore, the wide-angle lens may be employed to capture the target image 90, and determine at least one candidate region 10 in the target image 90 captured by the wide-angle lens. The telephoto lens has a relatively narrow field of view, and an adjustable focal length. In addition, the capturing angle of the telephoto lens may be controlled via a gimbal coupled to the telephoto lens. Compared with the wide-angle lens, the telephoto lens may provide clearer images with enhanced details, and possess a depth of field compression capability. As a result, the telephoto lens may be desirable for capturing images of scenes including fine details. Therefore, the telephoto lens may be employed to capture the region image 80 corresponding to the candidate region 10, thereby improving the detection accuracy.

In the present disclosure, through configuring the wide-angle lens as the first lens 2 with a larger capturing range, and configuring the telephoto lens as the second lens 3 with a smaller capturing range, the target image 90 corresponding to a larger scene may be captured via the wide-angle lens, and the region image 80 corresponding to a scene including more details may be captured via the telephoto lens. Thus, the characteristics of the wide-angle lens and the telephoto lens may be utilized, and the detection efficiency may be improved while the detection accuracy of the target objects of different sizes may be ensured, thereby enhancing the user experience.

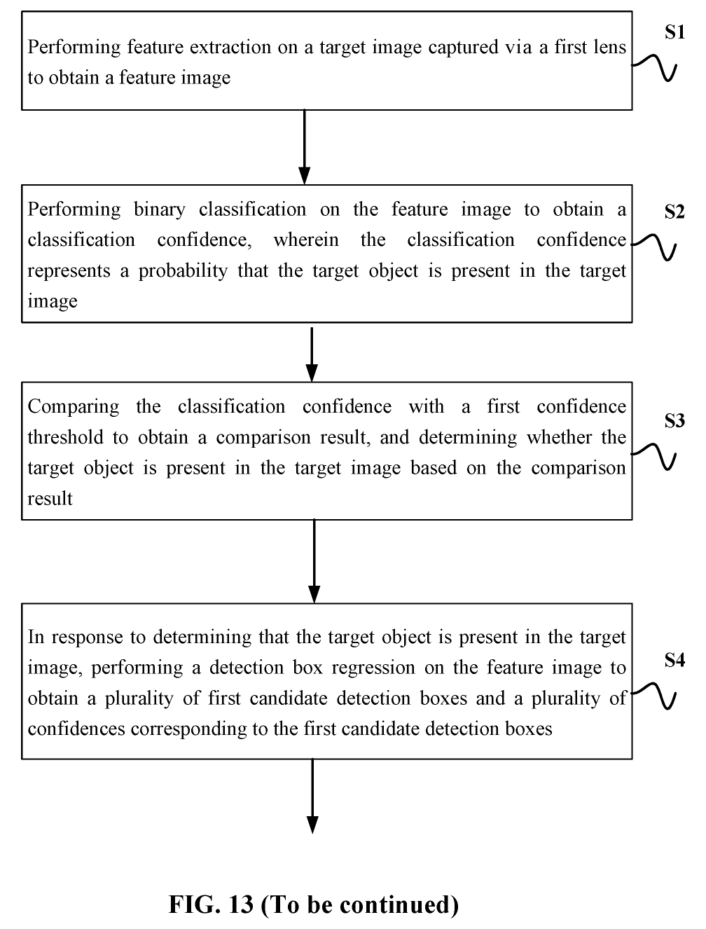

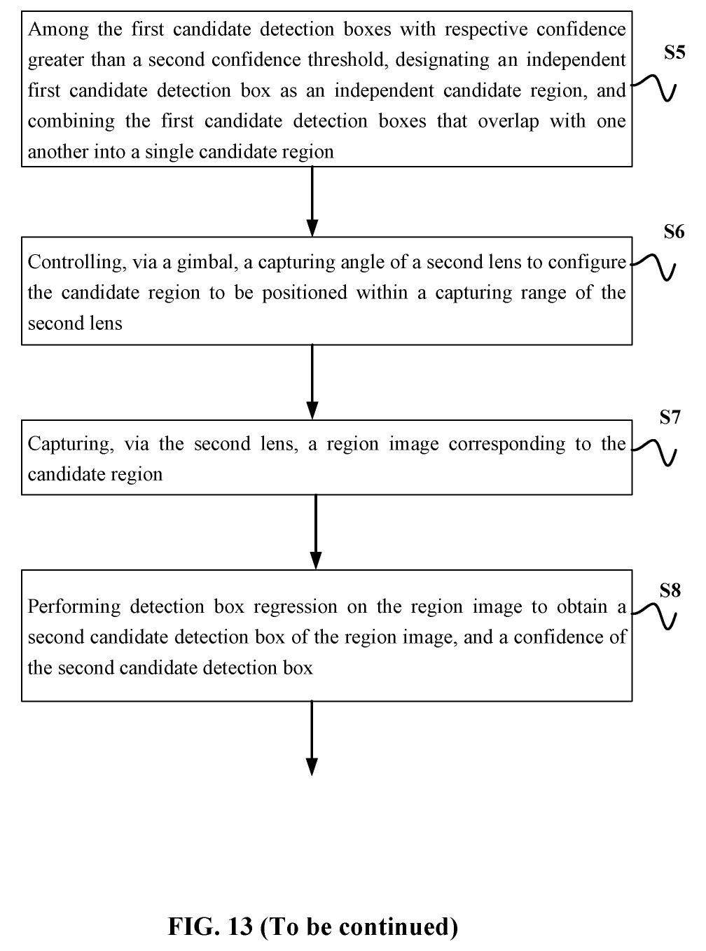

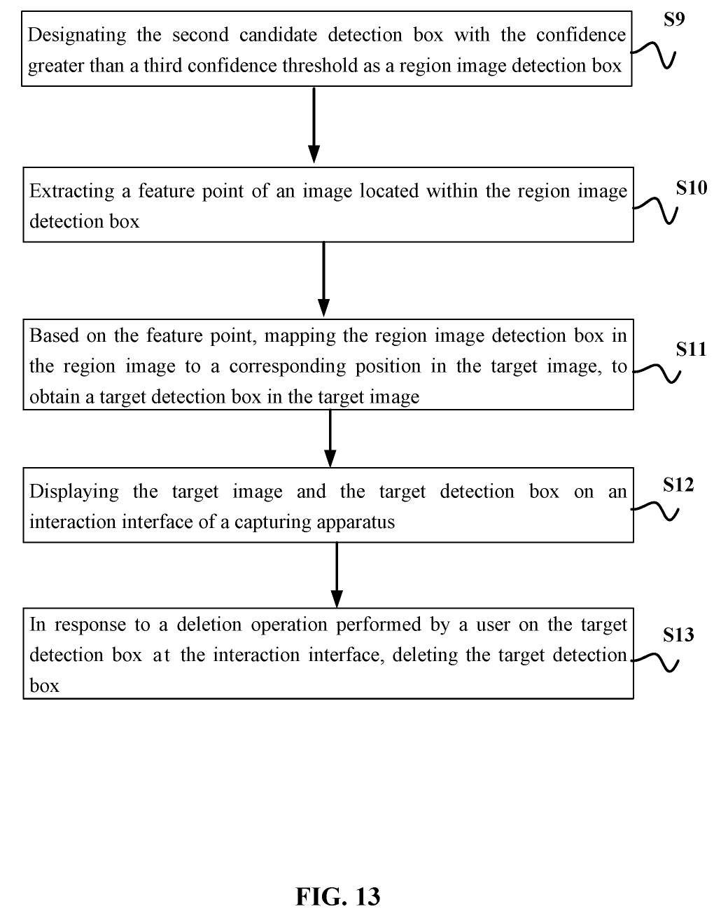

In some implementations, a detection method is provided, which may be applied to the capturing device 1. The capturing device 1 includes a first lens that may be a wide-angle lens, and a second lens that may be a telephoto lens. As shown in FIG. 13, the detection method includes the following operations.

Operation S1: performing feature extraction on a target image captured via a first lens to obtain a feature image.

Operation S2: performing binary classification on the feature image to obtain a classification confidence, where the classification confidence represents a probability that the target object is present in the target image.

Operation S3: comparing the classification confidence with a first confidence threshold to obtain a comparison result, and determining whether the target object is present in the target image based on the comparison result.

Operation S4: in response to determining that the target object is present in the target image, performing detection box regression on the feature image to obtain a plurality of first candidate detection boxes and a plurality of confidences corresponding to the first candidate detection boxes.

Operation S5: among the first candidate detection boxes with respective confidence greater than a second confidence threshold, designating an independent first candidate detection box as an independent candidate region, and combining the first candidate detection boxes that at least partially overlap with one another into a single candidate region.

Operation S6: controlling, via a gimbal, a capturing angle of a second lens to configure the candidate region to be positioned within a capturing range of the second lens.

Operation S7: capturing, via the second lens, a region image corresponding to the candidate region.

Operation S8: performing detection box regression on the region image to obtain a second candidate detection box of the region image, and a confidence of the second candidate detection box.

Operation S9: designating the second candidate detection box with the confidence greater than a third confidence threshold as a region image detection box.

Operation S10: extracting a feature point of an image located within the region image detection box.

Operation S11: based on the feature point, mapping the region image detection box in the region image to a corresponding position in the target image, to obtain a target detection box in the target image.

Operation S12: displaying the target image and the target detection box on an interaction interface of the capturing device.

Operation S13: in response to a deletion operation performed by a user on the target detection box at the interaction interface, deleting the target detection box.

In the present disclosure, through determining at least one candidate region 10 in the target image 90 captured via the first lens 2 (e.g., a wide-angle lens with a relative wide capturing range), and capturing, via the second lens 3 (e.g., the telephoto lens with a relatively narrow capturing range) to obtain the region image 80 corresponding to the candidate region 10, the region image detection box 20 of the target object may be determined in the region image 80. Through mapping the region image detection box 20 in the region image 80 to the target image 90, the target detection box 30 in the target image 90 may be obtained and, accordingly, the target object may be detected and presented to the user. Through selecting the candidate region 10 based on the target image 90 captured via the first lens 2 (e.g., the wide-angle lens), and determining the region image detection box 20 corresponding to the target object, based on the region image 80 that is corresponding to the candidate region 10 and captured via the second lens 3 (e.g., the telephoto lens), the detection efficiency may be improved while the detection accuracy of the target object may be ensured. Accordingly, the user experience may be enhanced.

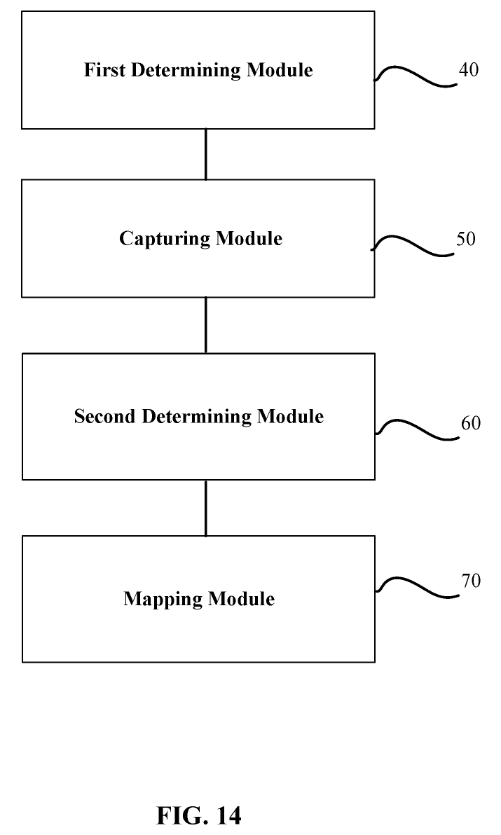

In the present disclosure, a detection device is provided, which may be implemented into the capturing device 1 illustrated in FIG. 1. Referring to FIG. 1, the capturing device 1 includes the first lens 2 and the second lens 3, and the capturing range of the second lens 3 is narrower than the capturing range of the first lens 2. As shown in FIG. 14, the detection device includes a first determining module 40, a capturing module 50, a second determining module 60, and a mapping module 70. The first determining module 40 may be configured to determine at least one candidate region 10 in a target image 90 captured via the first lens 2. The capturing module 50 may be configured to capture, via the second lens 3, a region image 80 corresponding to the candidate region 10. The second determining module 60 may be configured to determine a region image detection box 20 of a target object in the region image 80. The mapping module 70 may be configured to map the region image detection box 20 to the target image 90, and obtain a target detection box 30 in the target image 90.

In the present disclosure, the first determining module 40 may determine at least one candidate region 10 in the target image 90 captured via the first lens 2 with a relatively wide capturing range. The capturing module 50 may capture, via the second lens 3 with a relatively narrow capturing range, to obtain the region image 80 corresponding to the candidate region 10. The second determining module 60 may determine the region image detection box 20 of the target object in the region image 80. The mapping module 70 may map the region image detection box 20 in the region image 80 to the target image 90, thereby obtaining the target detection box 30 in the target image 90, and realizing the detection and presentation of the target object.

The candidate region 10 may be selected based on the target image captured via the first lens 2. Based on the region image 80 that is corresponding to the candidate region 10 and captured by the second lens 3, the region image detection box 20 corresponding to the target object may be determined. Thus, the detection efficiency of the detection device may be improved while the detection accuracy of the target object may be ensured, thereby enhancing the user experience.

In one implementation, the first determining module 40 may be further configured to determine whether the target object exists in the target image 90. In response to determining that the target object exists in the target image 90, the first determining module 40 may be configured to determine at least one candidate region 10 in the target image 90.

In one implementation, the first determining module 40 may be further configured to perform feature extraction on the target image 90 to obtain a feature image, and to perform binary classification on the feature image to obtain a classification confidence (or classification confidence score). The classification confidence may represent a probability that the target object exists in the target image 90. The first determining module 40 may be configured to compare the classification confidence with a first confidence threshold to obtain a comparison result. The first determining module 40 may be configured to determine whether the target object exists in the target image 90 based on the comparison result.

In one implementation, the first determining module 40 may be further configured to perform detection box regression on the feature image to obtain a plurality of first candidate detection boxes, and a plurality of confidences (or confidence scores) corresponding to the first candidate detection box. The first determining module 40 may be configured to select the first candidate detection boxes that have the respective confidences greater than a second confidence threshold. Among the first candidate detection boxes having the respective confidence greater than the second confidence threshold, the first determining module 40 may be configured to designate each independent first candidate detection box as an independent candidate region 10, and combine the first candidate detection boxes that at least partially overlap with one another into a single, independent candidate region 10.

In one implementation, the first confidence threshold may be configured to be inversely correlated with the second confidence threshold.

In one embodiment, the capturing module 50 may be further configured to perform the following capturing process on each candidate region 10. The capturing module 50 may be configured to control, via a gimbal, a capturing angle of the second lens 3 to configure the candidate region 10 to be located within a capturing range of the second lens 3. Then the capturing module 50 may be configured to capture, via the second lens 3, the region image 80 corresponding to the candidate region 10.

In one embodiment, a center of the candidate region 10 may be configured to coincide with a center of the capturing range of the second lens 3, and an area ratio of the candidate region 10 to the capturing range of the second lens 3 may be configured to be within a predetermined range.

In one embodiment, the second determining module 60 may be further configured to perform detection box regression on each region image to obtain a second candidate detection box of each region image 80, and obtain a confidence (or confidence score) of the second candidate detection box. The second determining module 60 may be further configured to determine the second candidate detection box with the confidence greater than a third confidence threshold as the region image detection box 20.

In one implementation, the third confidence threshold may be configured to be greater than the second confidence threshold.

In one implementation, the mapping module 70 may be further configured to extract one or more feature points of an image within the region image detection box 20 in the region image 80. The mapping module 70 may be further configured to, based on the one or more feature points, map the region image detection box 20 in the region image 80 to a corresponding position in the target image 90, and obtain the target detection box 30 in the target image 90.

In some implementations, the detection device may further include a display module. The display module may be configured to display the target image 90 and the target detection box 30 on an interaction interface (or a user interface) of the capturing device 1.

In some implementations, the detection device may further include a deletion module. The deletion module may be configured to, in response to a deletion operation performed by a user on the target detection box 30 at the interaction interface, delete the target detection box 30 to which the deletion operation is directed.

In one implementation, the first lens 2 may include a wide-angle lens, and the second lens 3 may include a telephoto lens.

The respective modules included in the detection device disclosed herein may be implemented by software, hardware, or a combination thereof. The respective modules in the detection device disclosed herein may be embedded in or independent of the processor in the computer apparatus in hardware form, or may be stored in the memory of the computer apparatus in software form, so that the processor can call and execute the operations corresponding to the respective modules.

In some implementations, a computer apparatus including a processor and a memory may be provided. The memory may store a computer program. When executed by the processor, the computer program may perform the operations of any detection methods disclosed herein.

In some implementations, a computer-readable storage medium may be provided. The computer-readable storage medium may store a computer program. When executed by a processor, the computer program may perform the operations of any of the detection methods disclosed herein. The computer-readable storage medium may include read-only memory (ROM), random access memory (RAM), Compact Disc Read-Only Memory (CD-ROM), a magnetic tape, a floppy disk, and an optical data storage device, etc.

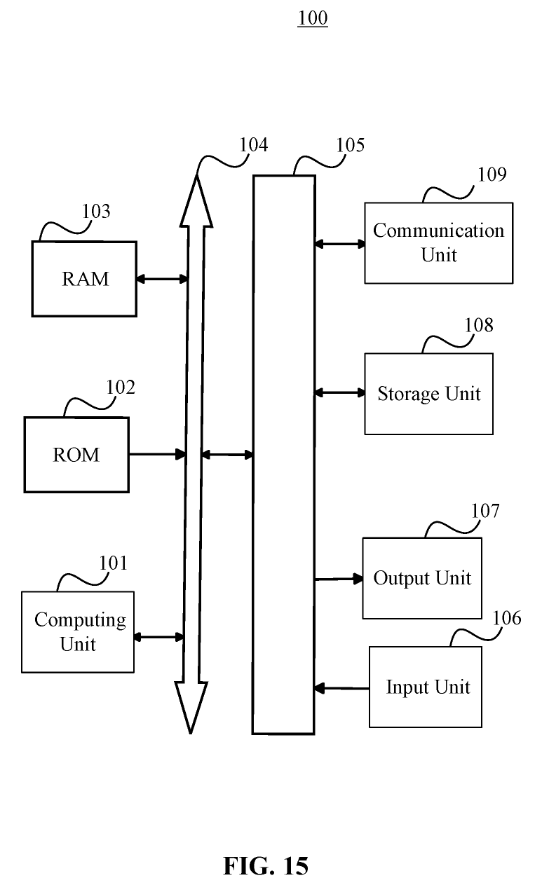

FIG. 15 is a block diagram of a computer apparatus 100, according to some embodiments of the present disclosure. The computer apparatus 100 may serve as the capturing device 1 disclosed herein. The computer apparatus 100 includes a computing unit 101, which may execute various appropriate actions and processing according to a computer program stored in ROM 102 or a computer program loaded from a storage unit 108 into RAM 103. Various programs and data required for the operation of the computer apparatus 100 may also be stored in the RAM 103. The computing unit 101, the ROM 102, and the RAM 103 may be connected to one other via a bus 104. An input/output (I/O) interface 105 may also be connected to the bus 104.

A plurality of components in the computer apparatus 100 may be connected to the I/O interface 105, including: an input unit 106, an output unit 107, a storage unit 108, and a communication unit 109. The input unit 106 may be any type of device capable of inputting information to the computer apparatus 100. The input unit 106 may receive input digital or character information, as well as generate key signal input related to settings and/or function control performed by a user of the computer apparatus 100. The input unit 106 may include, but is not limited to, a mouse, a keyboard, a touchscreen, a trackpad, a trackball, a joystick, a microphone, and/or a remote control. The output unit 107 may be any type of device capable of presenting information. The output unit 107 may include, but is not limited to, a display, a speaker, a video/audio output terminal, a vibrator, and/or a printer. The storage unit 108 may include, but is not limited to, a magnetic disk, optical disk. The communication unit 109 may allow the computer apparatus 100 to exchange information/data with other devices via a computer network, such as the Internet and/or various telecommunications networks. The communication unit 109 may include, but is not limited to, a modem, a network card, an infrared communication device, a wireless communication transceiver, and/or a chipset, such as a Bluetooth™ device, a WiFi device, a WiMax device, a cellular communication device, and/or the like.

The computing unit 101 may be various general-purpose and/or special-purpose processing components with processing and computing capabilities. Some examples of the computing unit 101 include, but are not limited to, a central processing unit (CPU), a graphics processing unit (GPU), various dedicated artificial intelligence (AI) computing chips, various computing units running machine learning model algorithms, digital signal processors (DSP), and any suitable processor, controller, microcontroller, etc. The computing unit 101 may execute the various methods and processing disposed herein, such as the detection method. For example, in some implementations, the detection method disclosed herein may be implemented as a computer software program, which is tangibly contained in a machine-readable medium, such as the storage unit 108. In some implementations, part or all of the computer program may be loaded and/or installed onto the computer apparatus 100 via the ROM 102 and/or the communication unit 109. When the computer program is loaded into the RAM 103 and executed by the computing unit 101, one or more operations of the detection method described above can be performed. In some implementations, the computing unit 101 may be configured to perform the detection method in any other suitable manner (for example, by means of firmware).

The computer apparatus 100 may be implemented by one or more application-specific integrated circuits (ASIC), digital signal processors (DSP), digital signal processing devices (DSPD), programmable logic devices (PLD), field programmable gate arrays (FPGA), controllers, microcontrollers, microprocessors, or other electronic components, for performing the detection method disclosed herein.

The implementations in the present disclosure are described in a progressive manner, with respective implementation focusing on the differences from other implementations. The same or similar parts among the various implementations may be referred to one another as needed.

In the present disclosure, references to the terms “implementation,” “exemplary implementation,” and the like mean that specific features, structures, materials, or characteristics described in connection with the implementation or example are included in at least one implementation or example of the present disclosure.

In the present disclosure, the schematic expressions of the above terms do not necessarily refer to the same implementation or example. Moreover, the specific features, structures, materials, or characteristics described may be combined in any suitable manner in one or more implementations or examples.

It can be understood that the terms “first,” “second,” and the like used in the present disclosure may be used to describe various structures, but these structures are not limited by these terms. These terms are only used to distinguish one structure from another.

In one or more drawings, the same elements are denoted by similar reference numerals. For clarity, multiple parts in the drawings are not drawn to scale. In addition, some well-known parts may not be shown. For simplicity, the structure obtained after several operations may be described in one drawing. Many specific details of the present disclosure, such as device structure, materials, dimensions, processing technology, and techniques, are described below to facilitate a clearer understanding of the present disclosure. However, as those skilled in the art can understand, the present disclosure can be implemented without these specific details.

Finally, it should be noted that the implementations disclosed herein are only used to illustrate the technical solutions of the present disclosure, and not to limit them. Although the present disclosure is described in detail with reference to the implementations disclosed herein, those skilled in the art should understand that modifications can still be made to the technical solutions described in the implementations disclosed herein, or some or all of the technical features can be equivalently replaced. These modifications or replacements do not cause the essence of the corresponding technical solutions to depart from the scope of the technical solutions of the implementations of the present disclosure.

In the detection method, detection device, computer apparatus, and computer-readable storage medium disclosed in the present disclosure, through determining at least one candidate region in a target image captured via a first lens with a larger capturing range, and through capturing, via a second lens with a smaller capturing range, to obtain a region image corresponding to at least one candidate region, a region image detection box of a target object may be determined in the region image. Through mapping the region image detection box to the target image, a target detection box in the target image may be obtained, realizing the detection and presentation of the target object. Through selecting the candidate region based on the target image captured by the first lens, and through determining the region image detection box corresponding to the target object based on the region image that is corresponding to the candidate region and captured via the second lens, the detection efficiency may be improved while the detection accuracy of the target object may be ensured, thereby enhancing the user experience.

What is claimed is:

1. A detection method for a capturing device, wherein the capturing device comprises a first lens having a first capturing range, and a second lens having a second capturing range that is smaller than the first capturing range, and the detection method comprises:
determining at least one candidate region in a target image captured via the first lens;
capturing, via the second lens, at least one region image corresponding to the at least one candidate region;
determining a region image detection box of a target object in the at least one region image; and
mapping the region image detection box to the target image to obtain a target detection box in the target image.

2. The detection method according to claim 1, wherein determining the at least one candidate region in the target image captured via the first lens comprises:
determining whether the target object is present in the target image; and
in response to determining that the target object is present in the target image, determining the at least one candidate region in the target image.

3. The detection method according to claim 2, wherein determining whether the target object is present in the target image comprises:
performing feature extraction on the target image to obtain a feature image;
performing binary classification on the feature image to obtain a classification confidence, wherein the classification confidence of the feature image represents a probability that the target object is present in the target image; and
comparing the classification confidence with a first confidence threshold to obtain a comparison result, and determining whether the target object is present in the target image based on the comparison result.

4. The detection method according to claim 3, wherein determining the at least one candidate region in the target image comprises:
performing detection box regression on the feature image to obtain a plurality of first candidate detection boxes and a plurality of confidences corresponding to the first candidate detection boxes; and
among the first candidate detection boxes with the respective confidences greater than a second confidence threshold, designating each independent first candidate detection box as each independent candidate region of the at least one candidate region, and combining the first candidate detection boxes that at least partially overlap with one another into a single candidate region of the at least one candidate region.

5. The detection method according to claim 4, wherein the first confidence threshold is configured to be inversely correlated with the second confidence threshold.

6. The detection method according to claim 1, wherein capturing, via the second lens, the region image corresponding to the at least one candidate region comprises:
controlling, via a gimbal, a capturing angle of the second lens to configure the at least one candidate region to be positioned within the second capturing range of the second lens; and
capturing, via the second lens, the region image corresponding to the at least one candidate region.

7. The detection method according to claim 1, wherein a center of the at least one candidate region is configured to coincide with a center of the second capturing range of the second lens, and an area ratio of the at least one candidate region to the second capturing range of the second lens is configured to be within a predetermined range.

8. The detection method according to claim 4, wherein determining the region image detection box of the target object in the at least one region image comprises:
performing detection box regression on the at least one region image to obtain a second candidate detection box in the at least one region image and a confidence of the second candidate detection box; and
designating the second candidate detection box with the confidence greater than a third confidence threshold as the region image detection box.

9. The detection method according to claim 8, wherein the third confidence threshold is configured to be greater than the second confidence threshold.

10. The detection method according to claim 1, wherein mapping the region image detection box to the target image, to obtain the target detection box in the target image comprises:
extracting a feature point of an image within the region image detection box; and
based on the feature point, mapping the region image detection box in the at least one region image to a corresponding position in the target image, to obtain the target detection box in the target image.

11. The detection method according to claim 1, further comprising:
displaying the target image and the target detection box at a user interface of the capturing device.

12. The detection method according to claim 11, further comprising:
in response to a deletion operation performed by a user on the target detection box at the user interface, deleting the target detection box.

13. The detection method according to claim 1, wherein the first lens comprises a wide-angle lens, and the second lens comprises a telephoto lens.

14. A detection device, implemented into a capturing device, wherein the capturing device comprises a first lens having a first capturing range, and a second lens having a second capturing range smaller than the first capturing range, and the detection device comprises:
a first determining module, configured to determine at least one candidate region in a target image captured via the first lens;
a capturing module, configured to capture, via the second lens, at least one region image corresponding to the at least one candidate region;
a second determining module, configured to determine a region image detection box of a target object in the at least one region image; and
a mapping module, configured to map the at least one region image detection box to the target image, to obtain a target detection box in the target image.

15. The detection device according to claim 14, wherein the first determining module is further configured to:
determine whether the target object is present in the target image; and
in response to determining that the target object is present in the target image, determine the at least one candidate region in the target image.

16. The detection device according to claim 15, wherein the first determining module is further configured to:
perform feature extraction on the target image to obtain a feature image;
perform binary classification on the feature image to obtain a classification confidence, wherein the classification confidence of the feature image represents a probability that the target object is present in the target image; and
compare the classification confidence with a first confidence threshold to obtain a comparison result, and determine whether the target object is present in the target image based on the comparison result.

17. The detection device according to claim 16, wherein the first determining module is further configured to:
perform detection box regression on the feature image to obtain a plurality of first candidate detection boxes and a plurality of confidences corresponding to the first candidate detection boxes; and
among the first candidate detection boxes with the respective confidences greater than a second confidence threshold, designate each independent first candidate detection box as each independent candidate region of the at least one candidate region, and combine the first candidate detection boxes that at least partially overlap with one another into a single candidate region of the at least one candidate region, and
wherein the first confidence threshold is inversely correlated with the second confidence threshold.

18. The detection device according to claim 17, wherein the second determining module is further configured to:
performing detection box regression on the at least one region image to obtain a second candidate detection box in the at least one region image and a confidence of the second candidate detection box; and
designating the second candidate detection box with the confidence greater than a third confidence threshold as the region image detection box,
wherein the third confidence threshold is configured to be greater than the second confidence threshold.

19. The detection device according to claim 14, wherein the capturing module is further configured to:
control, via a gimbal, a capturing angle of the second lens to configure the at least one candidate region to be positioned within the second capturing range of the second lens; and
capture, via the second lens, the region image corresponding to the at least one candidate region.

20. The detection method according to claim 1, wherein the mapping module is further configured to:
extract a feature point of an image within the region image detection box; and
based on the feature point, map the region image detection box in the at least one region image to a corresponding position in the target image, to obtain the target detection box in the target image.
